(19) United States
(12) Patent Application Publication
(10) Pub. No.: US 2014/0021400 A1
(43) Pub. Date: Jan. 23, 2014

(54) PRINTABLE ETCHANT COMPOSITIONS FOR ETCHING SILVER NANOWARE-BASED TRANSPARENT, CONDUCTIVE FILM

(71) Applicant: Christopher Coenjarts, New York, NY (US)

(72) Inventor: Christopher Coenjarts, New York, NY (US)

(73) Assignee: Sun Chemical Corporation, Parsippany, NJ (US)

(21) Appl. No.: 13/994,287

(22) PCT Filed: Dec. 15, 2011
(86) PCT No.: PCT/US11/65288

§ 371 Date: Oct. 2, 2013

Related U.S. Application Data
(60) Provisional application No. 61/423,321, filed on Dec. 15, 2010.

(51) Int. Cl. C09K 13/06

(52) U.S. Cl. CPC C09K 13/06
USPC 252/79.4

(57) ABSTRACT

The present invention relates to a novel printable paste composition and its use in etching conductive films formed by a plurality of interconnecting silver nano-wires. After etching, the conductive film has a pattern of conductive and non-conductive areas with low visibility. The etched films are suitable as a transparent electrode in visual display devices such as touch screens, liquid crystal displays, plasma display panels and the like.

### RELATED APPLICATIONS

Benefit of priority is claimed to U.S. Provisional Application Ser. No. 61/423,321, filed Dec. 15, 2010, entitled “SCREEN PRINTABLE PASTE FOR ETCHING SILVER NANOWIRE-BASED TRANSPARENT, CONDUCTIVE FILMS,” to Christopher Coenjarts.

Where permitted, the subject matter of the above-referenced applications is incorporated by reference herein in its entirety.

### FIELD OF THE INVENTION

The present invention relates to chemical etching, particularly to a printable etching composition, including a printable etching paste composition, and uses thereof in etching conductive films, such as conductive films formed by a plurality of interconnecting silver nanowires (e.g., ClearOhm™ films from Cambrios Technologies Corp., Sunnyvale, Calif. USA). After etching, the conductive film has a pattern of conductive and non-conductive areas. The etching can provide low visibility etching patterns and low conductivity patterns on the film. The etched films are suitable, e.g., as a transparent electrode in visual display devices such as, e.g., touch screens, liquid crystal displays, and plasma display panels.

### BACKGROUND OF THE INVENTION

Silver nanowire transparent conductive films provide good transparency, low visibility, and good electrical and mechanical properties. Such films may be used in various electronic applications, such as touch screen displays. Depending upon the application, it is sometimes necessary to create a desired pattern in the silver nanowire films. For example, the films may be patterned into conductive areas, and non-conductive areas to form electrodes, connecting wires, or similar structures. These patterned areas can be formed by chemical etching.

The use of an etchant bath to create etched patterns on metal, including on nanowire-based conductors, is known in the art (e.g., see U.S. Pat. Pub. Appl. Nos. US2011/0017608 A1; US2010/0300889 A1; US2010/0243295 A1 and US2008/0003404 A1; and U.S. Pat. Nos. 6,500,350 B1; 5,650,075 B2). The use of etchant baths to create etched patterns is a multi-step process, typically involving:
1. Printing an etch resist on a sample.
2. Drying the etch resist.
3. Submerging sample in etchant.
4. Neutralizing/Rinsing the sample.
5. Stripping the etch resist off of the sample.
6. Rinsing the sample; and
7. Drying the sample.

If the preparation of the etch resist requires photolithographic patterning, even more steps are required. These additional steps and materials add expense and time.

Further, not all etchant chemistries are suitable for use in printable etchant composition, such as an etchant ink or printable etchant paste. Moreover, some formulations are unsuitable for printing relatively small line widths.

Thus, a need exists for an etchant and a process for etching a substrate that involves fewer materials and process steps than the more traditional methods based on etch resists and etchant baths.

### SUMMARY OF THE INVENTION

Provided herein are printable etchant compositions, including printable etchant pastes, and methods of use thereof that require fewer materials and process steps than the more traditional methods based on etch resists and etchant baths.

Provided are printable etchant compositions for etching a substrate, where the printable etchant compositions contain an acid-etching component containing an oxidizing agent and an acid; a solvent; and a resin. The printable etchant composition has a viscosity suitable for non-contact printing or contact printing. The printable etchant compositions provided herein can be applied to a substrate using any printing method known in the art, including non-contact printing methods, such as aerosol jet printing, continuous inkjet printing and drop-on-demand inkjet printing, as well as contact printing methods, such as flat bed screen printing, rotary screen printing, reverse gravure printing and flexography. The substrate can be a transparent conductive film, such as a transparent conductive film formed by a plurality of interconnecting silver nanowires.

The printable etchant compositions are formulated to have a viscosity suitable for printing via a contact or non-contact printing method. For example, for some non-contact printing methods, such as inkjet printing, the printable etchant composition can have a viscosity that is less than 20 cP at 10 sec⁻¹ at 25° C. For aerosol jet printing, the printable etchant composition can have a viscosity that is between 30 cP and 1000 cP at 10 sec⁻¹ at 25° C. For contact printing methods, the printable etchant composition can have a viscosity that is between 5 cP and 4,000 cP at 10 sec⁻¹ at 25° C., such as a viscosity that is greater than 500 cP at 10 sec⁻¹ at 25° C.

Any oxidizing agent known in the art, such as an oxidizing agent is selected from among cupric chloride, bromine, chlorine, iodine, iron nitrate, iron chloride, sodium hypochlorite, hydrogen peroxide, ammonium hydroxide, ammonium monopersulfate, potassium monopersulfate, sodium monopersulfate, ammonium persulfate, potassium persulfate, sodium persulfate, sodium or potassium peroxydisulfate, ferric nitrate, potassium iodate, acetic hydro-peroxide, potassium permanganate and potassium iodide and combinations thereof, can be included in the composition. Any acid known in the art, such as hydrochloric acid, bromic acid, chloric acid, nitric acid, nitrous acid, sulfuric acid, sulfurous acid, persulfuric acid, phosphoric acid, carboxylic acid group-containing compounds and sulfonic acid group-containing compounds and combinations thereof, can be included in the compositions. A preferred acid-etching component contains cupric chloride and hydrochloric acid.

Also provided are methods of etching a substrate by printing an etchant composition provided herein onto the substrate. The methods produce on a substrate an etched area that has a resistance greater than 10000 ohm/sq., or greater than 15,000 ohm/sq. The methods produce on a substrate an etched area that has a resistance that is at least 50× higher than an un-etched area of the substrate. The methods produce on a substrate an etched area that is at least 200 times less conductive than the non-etched areas of the substrate. The methods produce on a substrate an etched area that has a transparency similar to the non-etched areas of the substrate.

Also provided are methods of etching a pattern on a transparent conductive film, the methods including preparing a printable etchant fluid containing an oxidizing agent, an acid and a resin; printing the etching fluid onto the film to form a pattern; and removing the etching fluid to reveal the etched pattern on the film. In a preferred method, the oxidizing agent is cupric chloride and the acid is hydrochloric acid. The methods produce on a substrate an etched pattern having a low conductivity and a transparency similar to the non-etched areas of the substrate.

Any of the printable etchant compositions provided herein can be used to print a pattern of optically similar conductive and non-conductive areas on a substrate. The printing can be via a contact or non-contact printing method.

### DETAILED DESCRIPTION OF THE INVENTION

It is to be understood that the foregoing general description and the following detailed description are exemplary and explanatory only and are not restrictive of any subject matter claimed.

The section headings used herein are for organizational purposes only and are not to be construed as limiting the subject matter described.

### I. DEFINITIONS

Unless defined otherwise, all technical and scientific terms used herein have the same meaning as is commonly understood by one of skill in the art to which the inventions belong.

All patents, patent applications, published applications and publications, websites and other published materials referred to throughout the entire disclosure herein, unless noted otherwise, are incorporated by reference in their entirety for any purpose.

In this application, the use of the singular includes the plural unless specifically stated otherwise.

In this application, the use of “or” means “and/or” unless stated otherwise. As used herein, use of the term “including” as well as other forms, such as “includes,” and “included,” is not limiting.

As used herein, ranges and amounts can be expressed as “about” a particular value or range. “About” is intended to also include the exact amount. Hence “about 5 percent” means “about 5 percent” and also “5 percent.” “About” means within typical experimental error for the application or purpose intended.

As used herein, “optional” or “optionally” means that the subsequently described event or circumstance does or does not occur, and that the description includes instances where said event or circumstance occurs and instances where it does not. For example, an optional component in a system means that the component may be present or may not be present in the system.

As used herein, “transparent” means substantially transmitting visible light.

As used herein, “low visibility” with reference to the etched areas of a film refers to the etched areas appearing visually very similar to the non-etched areas, i.e. having very similar transparency, so that the film looks uniform.

As used herein, “optically similar” means that the transmittance of visible light is similar or the same. When etched areas are optically similar to non-etched areas, the etched area and un-etched areas transmit visible light in similar manner similar, so that the substrate has a uniform appearance.

### II. ETCHANT CHEMISTRY

There are many examples in the prior art of aqueous solutions and etchant baths used for etching metals, particularly silver. Examples include potassium iodide; iodine; iron nitrate; iron chloride; hydrochloric acid; cupric chloride; ammonium hydroxide; hydrogen peroxide; sodium persulfate; and acids. Such aqueous solutions are used in the etchant bath process described above.

While these components may be adequate for etching when used in an etchant bath, the chemistries of many of these compounds are incompatible for formulation as a printable etchant composition, such as an etchant paste. For example, iron nitrate is reactive with many organic solvents, including many of those suitable for printing processes, and the reactive nature of iron nitrate generally results in shelf life and storage stability problems.

Ammonium hydroxide often is used in etchant baths. This chemical can release ammonia vapors over time, and ammonia is an irritant and corrosive to the eyes, respiratory tract and mucous membranes. Contact of ammonium hydroxide with silver oxide or hypochlorites cab result in the formation of explosive peroxide compounds. Shelf life and storage stability problems tend to be a problem for formulations including ammonium hydroxide. Hydrogen peroxide, although used in baths, also tends to exhibit long-term stability problems and thus would not be suitable for use in an etchant paste. Similarly, sodium persulfate is useful in freshly prepared baths but it has a short shelf life in aqueous solution (reported to be about 2 weeks) and thus would be unsuitable for use in an etchant paste.

Others etchants commonly used in etching baths are poorly suited for use with silver nano-wire based transparent conductive films. For example, while potassium iodide and iodine are used in etchant baths for etching some metals, etchants containing potassium iodide or iodine have been found to be prone to discolor the film and stain screens and squeegees used for application of the etchant. Similarly, iron chloride etchant solution also have been found to discolor the film after annealing. Several acids, including mineral and organic acids, can be used alone as etchants in etchant baths, but their use as the sole etchant on nano-wire based transparent conductive films have been found to produce mid to high visibility patterns on the substrate after etching.

Is has been found that the cupric chloride, alone or in combination with an acid, such as hydrochloric acid, in the printable etchant compositions provided herein represents preferred materials to incorporate into a printable etchant composition, such as a printable etchant paste formulation, which satisfies the main requirements of a printable etchant composition, such as a printable etchant paste: printability, etching power, low visibility etching patterns, ease of stripping; and shelf-life stability. Though this is the preferred chemistry, other chemistries alone or in combination with a cupric chloride, hydrochloric acid system described throughout this application also could be formulated into effective etching pastes suitable for use with nanowire-based transparent conductive films.

### III. PRINTABLE ETCHANT COMPOSITIONS

Provided herein are printable etchant compositions, e.g., etchant formulations printable on a substrate via non-contact printing, e.g., by continuous or drop-on-demand ink jet or aerosol jet printing or via suitable forms of contact printing, including but not limited to flat bed screen, rotary screen, reverse gravure and flexography, and methods of etching that includes application of the printable etchant compositions for etching conductive films, including silver nanowire-based transparent conductive films (e.g., ClearOhm™ films from Cambrios Technologies Corp. (Sunnyvale, Calif. USA); see e.g., U.S. Pat. Pub. Appl. Nos. US2011/0297642 A1; US2011/0285019 A1; US2011/0253668 A1; US2011/0230996 A1; US2011/0174364 A1; US2011/0088770 A1; and US2010/0243295 A1; and U.S. Pat. Nos. 8,049,333 B2; 8,018,568 B2; and 8,018,563 B2) to produce low visibility and low conductivity patterns on the conductive films. The printable etchant compositions provided herein include an acid-etching component. Preferred acid-etching components of the printable etchant compositions, including printable etchant paste compositions, provided herein include an oxidizing metal salt and an acid, particularly cupric chloride and hydrochloric acid.

The prior art describes printable/dispensable etching pastes for etching transparent conductive oxide layers (e.g., indium tin oxide; see US Pat. Appl. Pub. Nos. US2008/0210660; US2010/0068890; and US 2008/0217576; and U.S. Pat. No. 5,688,366) and various other inorganic surfaces, e.g., SiO, SiNₓ, titanium dioxide, Si (see US Pat. Appl. Pub. Nos. US2010/0068889; US2005/0247674; US2008/0200036; US2008/0121621; US2006/0118759 and US2003/0160026; and U.S. Pat. Nos. 7,196,018 B2; and 7,629,257 B2). The printable/dispensable etchants described in the prior art describe various etching chemistries, including iron chloride (see US Pat. Appl. Pub. No. US 2008/0210660 A1 and U.S. Pat. No. 5,688,366); phosphoric acid (see US Pat. Appl. Pub. Nos. US 2010/0068890 A1 and US2008/0217576 A1 and U.S. Pat. No. 7,629,257 B2); caustic (see US Pat. Appl. Pub. Nos. US2010/0068889 A1; US2005/0247674 A1 and US2008/0200036 A1; and U.S. Pat. No. 7,196,018 B2); and fluoride salts (see US Pat. Appl. Pub. Nos. US2008/0121621 A1; US2006/0118759 A1 and US2003/0160026 A1). A generic description of solvents, resins and various print additives is typical in these publications.

It would be expected that the iron chloride containing pastes and the phosphoric acid containing pastes could have some ability to etch the silver nanowires in the transparent conductive films under consideration here. For example, U.S. Pat. No. 5,688,366 purportedly describes an iron chloride based paste that can be used for etching transparent conductive oxides. A latter reference (US Pat. Appl. Pub. No. US2010/0068890 A1), however, describes these pastes as being unsuitable for printing lines of width less than 1 mm. Similarly, the pastes described in US Pat. Appl. Pub. No. 2008/0210660 A1 use iron chloride as an etchant for transparent conductive oxides. The only mention of printed line widths in this publication indicates that lines having a width between 0.45 to 0.55 mm can be achieved. It is possible that these iron chloride based pastes could etch the nanowire-based transparent conductive films under consideration here but they may not be able to achieve the fine line printing of which the ink compositions of the instant invention is capable (e.g., <0.2 mm). Other possible problems encountered with iron chloride based aqueous etchant baths include discoloration during film annealing and the pastes not being easily stripped from the films after baking.

US Pat. Appl. Pub. Nos. US2010/0068890 A1 and US 2008/0217576 A1 describe etchant pasts containing a phosphoric acid as an etchant for etching transparent conductive oxides. These types of compositions may be effective in etching the nanowire-based transparent conductive films under consideration here; but early work with acid-only based etchant solutions indicate that they were prone to yielding films with etch patterns that do not have the desired low visibility. None of the prior art concerning printable etchant paste compositions include cupric chloride nor use of a printable etchant paste containing cupric chloride for etching nanowire-based transparent conductive films.

The printable etchant compositions, including printable etchant paste compositions provided herein preferably contain an acid-etching component, solvent(s), and a resin(s), and can include thixotrope(s), optionally an acid(s), and optionally print additives, such as anti-foaming agents, de-aerators, flow additives, rheology modifiers, wetting agents and biocides.

A. Acid-Etching Component

The printable etchant compositions provided herein contain an acid-etching component. The acid-etching component contains an oxidizing agent and an acid. Oxidizing agents that can be included in the acid-etching component in the printable etchant compositions, including printable etchant paste compositions provided herein can be chosen from among oxidizing agents known in the art. Oxidizing agents known in the art include, but are not limited to, oxidizing metal salts (cobalt salts, copper salts, manganese salts, palladium salts, silver salts), oxidizing metal complexes, peroxides, halogens or halogen-based oxidizing salts, chlorates, perchlorates, perbromates, periodates, permanganates, peroxo compounds, sulfates, persulfates, and monopersulfates. Examples of suitable oxidizing agents that can be included in the acid etching component include, but are not limited to, cupric chloride, bromine, chlorine, iodine, iron nitrate, iron chloride, sodium hypochlorite, hydrogen peroxide, ammonium hydroxide, ammonium monopersulfate, potassium monopersulfate, sodium monopersulfate, ammonium persulfate, potassium persulfate, sodium persulfate, sodium or potassium peroxydisulfate, ferric nitrate, potassium iodate, acetic hydroperoxide, potassium permanganate and potassium iodide and combinations thereof.

An oxidizing agent or a combination of oxidizing agents generally is present in the range of 0.25%-15% by weight and preferably in the range of 0.5-10% by weight of the etchant composition. The oxidizing agent can be present in an amount that is greater than at or about 1% or greater than at or about 2% or greater than at or about 6% or greater than at or about 8% or greater than at or about 10% based on the weight of the etchant composition. The oxidizing agent can be present in an amount that is less than 10% based on the weight of the etchant composition. The oxidizing agent can be present in an amount that is 0.25%, 0.5%, 0.75%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5% or 15% based on the weight of the printable etchant composition.

The acid-etching component also contains an acid. Any acid known in the art can be included in the acid-etching component. Exemplary acids include hydrochloric acid, bromic acid, chloric acid, nitric acid, nitrous acid, sulfuric acid, sulfurous acid, persulfuric acid, phosphoric acid, carboxylic acid group-containing compounds and sulfonic acid group-containing compounds. Preferred acids contained in the printable etchant compositions provided herein include, alone or in combination, an inorganic mineral acid selected from among hydrochloric acid, phosphoric acid, sulfuric acid, nitric acid; and organic acids.

An acid or a combination of acids generally is present in the range of 0.25%-15% by weight and preferably in the range of 0.5-10% by weight. The acid can be present in an amount that is 0.25%, 0.5%, 0.75%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5% or 15% based on the weight of the printable etchant composition.

A preferred acid-etching component that can be included in the printable etchant compositions, including printable etchant paste compositions provided herein, includes an oxidizing metal salt and an acid, preferably cupric chloride in combination with an acid, such as hydrochloric acid.

The ratio of oxidizing metal salt to acid ranges from at or about 1:1 oxidizing metal salt to acid to at or about 9:1 oxidizing metal salt to acid. For example, the ratio of oxidizing metal salt to acid can be 1:1, 1.5:1, 2:1, 2.5:1, 3:1, 3.5:1, 14:1, 4.5:1, 15:1, 5.5:1, 6:1, 6.5:1, 7:1, 7.5:1, 8:1, 8.5:1 or 9:1.

The acid-etching component generally is present in the range of 1-20% by weight of the printable etchant composition and preferably in the range of 2-15% by weight. of the weight of the printable etchant composition. The acid-etching component can be present in an amount that is 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5% or 20% based on the weight of the printable etchant composition.

B. Solvent

The printable etchant compositions provided herein include a solvent or a combination of solvents.

1. Pastes

The printable etchant compositions can be formulated as etchant paste compositions for application to a substrate via suitable forms of contact printing including flat bed screen, rotary screen, reverse gravure and flexography. Any solvent that yields a homogeneous paste when combined with the other components in the printable etchant composition can be included in the composition. Non-limiting examples of preferred solvents for the printable etchant paste compositions, include, alone or in combination, water, mono- or polyhydric alcohols such as glycerol, 1,2-propanediol, 1,4-butanediol, 1,3-butanediol, 1,5-pentanediol, and 2-ethyl-1-hexenol, ethylene glycol, diethylene glycol, dipropylene glycol, a polyethylene glycol and N-methyl-pyrrolidone. When used, the molecular weight of the polyethylene glycol (PEG) can be selected to provide the desired viscosity of the paste. For example, a molecular weight of PEG can be in the range of between 100 and 8000, preferably between 200 and 4000. In some instance, the molecular weight of the PEG can be selected to be less than 2000. In some instances, the PEG has a molecular weight of at or about 100, 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900 or 4000.

2. Aerosol Jet Printable Etchant Compositions

The printable etchant compositions provided herein also can be formulated to be deposited on a substrate using an aerosol jet printer. The aerosol jet printing process uses aerodynamic focusing for the high-resolution deposition of colloidal suspensions and/or solutions. The aerosol jet printing process begins with a mist generator that atomizes a source material. Mist generation generally is accomplished using an ultrasonic or pneumatic atomizer. The aerosol stream is then focused using a flow deposition head, which forms an annular, co-axial flow between the aerosol stream and a sheath gas stream. Particles in the resulting aerosol stream then can be refined in a virtual impactor and further treated on the fly to provide optimum process flexibility. The co-axial flow exits the print head through a nozzle directed at the substrate. The aerosol stream of the deposition material can be focused, deposited, and patterned onto a planar or 3D substrate. The aerosol jet print head is capable of focusing an aerosol stream to as small as a tenth of the size of the nozzle orifice (typically 100 μm).

For printable etchant compositions formulated for application using aerosol jet printers, volatile solvents tend to be stripped out quickly, resulting in changes in viscosity and atomization and application properties, and can lead to lowered output rate and clogging of the atomizer components or the aerosol jet printer. Choosing a solvent with high boiling point and low vapor pressure is preferred for printable etchant compositions for application to a substrate via aerosol jet printing. Solvent with less than about 1 mmHg vapor pressure, preferably less than about 0.1 mmHg vapor pressure, are preferred, since solvents with vapor pressure higher than 1 mmHg generally will be stripped more quickly and thus are less preferred choices.

Any solvent having a boiling point of 100° C. or greater and a low vapor pressure, such as 1 mmHg vapor pressure or less, can be included in the printable etchant compositions formulated for application using aerosol jet printers provided herein. For example, a low vapor pressure solvent having a boiling point of 100° C. or greater, or 125° C. or greater, or 150° C. or greater, or 175° C. or greater, or 200° C. or greater, or 210° C. or greater, or 220° C. or greater, or 225° C. or greater, or 250° C. or greater, can be selected.

Examples of preferred low vapor pressure solvents include but are not limited to any one or combination of diethylene glycol monobutyl ether; 2-(2-ethoxyethoxy)ethyl acetate; ethylene glycol; terpineol; trimethylpentanediol monoisobutyrate; 2,2,4-trimethyl-1,3-pentanediol monoisobutyrate (Texanol); dipropylene glycol monoethyl ether acetate (DOWANOL® DPMA); tripropylene glycol n-butyl ether (DOWANOL® TPnB); propylene glycol phenyl ether (DOWANOL® PPh); dipropylene glycol n-butyl ether (DOWANOL® DPnB); dimethyl glutarate (DBE5 Dibasic Ester); dibasic ester mixture of dimethyl glutarate and dimethyl succinate (DBE 9 dibasic ester); tetradecane, glycerol; phenoxy ethanol (Phenyl Cellosolve®); dipropylene glycol; benzyl alcohol; acetophenone; 2,4-heptanediol; gamma-butyrolactone; phenyl carbitol; methyl carbitol; hexylene glycol; diethylene glycol monoethyl ether (Carbitol™); 2-butoxyethanol (Butyl Cellosolve®); 1,2-dibutoxyethane (Dibutyl Cellosolve®); 3-butoxybutanol; and N-methylpyrrolidone.

3. Inkjet Printable Etchant Compositions

The printable etchant compositions provided herein can be deposited on a substrate using an inkjet printer. For printable etchant compositions formulated for application using inkjet printers, volatile solvents can be used, alone or in combination with any of the low vapor pressure solvents described above. Exemplary higher vapor pressure solvents include C₁-C₆ alcohol, such as ethanol, n-propanol, isopropanol and butanol; water; amyl acetate; butyl acetate; butyl ether; dimethylamine (DMA); toluene; and N-methyl-2-pyrrolidone (NMP).

4. Solvent Concentrations

The solvent or combination of solvents in the printable etchant compositions generally is present in an amount greater than 25% based on the weight of the etchant compositions. The solvent or combination of solvents in the printable etchant compositions can be present in the range of 50-95% by weight and preferably in the range of 70-90% based on the weight of the printable etchant composition. The solvent can be present in the printable etchant compositions, including printable etchant paste compositions provided herein in an amount that is 50%, 50.5%, 51%, 51.5%, 52%, 52.5%, 53%, 53.5%, 54%, 54.5%, 55%, 55.5%, 56%, 56.5%, 57%, 57.5%, 58%, 58.5%, 59%, 59.5%, 60%, 60.5%, 61%, 61.5%, 62%, 62.5%, 63%, 63.5%, 64%, 64.5%, 65%, 65.5%, 66%, 66.5%, 67%, 67.5%, 68%, 68.5%, 69%, 69.5%, 70%, 70.5%, 71%, 71.5%, 72%, 72.5%, 73%, 73.5%, 74%, 74.5%, 75%, 75.5%, 76%, 76.5%, 77%, 77.5%, 78%, 78.5%, 79%, 79.5%, 80%, 80.5%, 81%, 81.5%, 82%, 82.5%, 83%, 83.5%, 84%, 84.5%, 85%, 85.5%, 86%, 86.5%, 87%, 87.5%, 88%, 88.5%, 89%, 89.5% 90%, 90.5%, 91%, 91.5%, 92%, 92.5%, 93%, 93.5%, 94%, 94.5%, or 95% based on the weight of the printable etchant composition.

C. Resin

The printable etchant compositions provided herein include a resin or a combinations of resins. Resins which can be used in this paste include but are not limited to, polyethylene glycol; cellulose, cellulose derivatives, such as ethyl cellulose, methyl cellulose, carboxymethyl cellulose, hydroxypropyl cellulose, hydroxypropyl methyl cellulose, and cellulose acetate, starch/starch derivatives; polypropylene glycol, cellulose acetate butyrate; xanthan gum; polyvinyl pyrrolidone and polymers based on acrylates or functionalized vinyl units, and combinations thereof. Other exemplary resins include homo- and copolymers of vinylpyrrolidone, polyvinyl alcohol, polyvinyl acetate, polyethylene glycols, copolymers of styrene and acrylate, copolymers of acrylic acid and methacrylic acid, copolymers of methacrylic acid and ethylacrylate, copolymers of methyl methacrylate and methacrylate, copolymers of acrylic acid and tertiary amino alkyl methacrylate, copolymers of methacrylate and tertiary amino alkyl methacrylate, copolymers of ethylacrylate methyl methacrylate and quaternary amino alkyl methacrylate, rhamsan gum, gellan gum, diutan gum, curdlan, gum arabic, chitosan and dextrans. Polyvinyl pyrrolidone is a preferred resin in the printable etchant compositions provided herein. The resins can be used alone or in combination.

The resin or combination of resins generally is present in an amount greater than 0.1% or greater than 0.5% based on the weight of the etchant composition. The resin or combination of resins can be present in the range of 0.5%-15% based on the weight of the etchant composition and preferably in the range of 0.5-10% based on the weight of the etchant composition. The resin can be present in an amount that is 0.1%, 0.2%, 0.3%, 0.4%, 0.5%, 0.6%, 0.7%, 0.8%, 0.9%, 1%, 1.25%, 1.5%, 1.75%, 2%, 2.25%, 2.5%, 2.75%, 3%, 3.25%, 3.5%, 3.75%, 4%, 4.25%, 4.5%, 4.75%, 5%, 5.25%, 5.5%, 5.75%, 6%, 6.25%, 6.5%, 6.75%, 7%, 7.25%, 7.5%, 7.75%, 8%, 8.25%, 8.5%, 8.75%, 9%, 9.25%, 9.5%, 9.75%, 10%, 10.25%, 10.5%, 10.75%, 11%, 11.25%, 11.5%, 11.75%, 12%, 12.25%, 12.5%, 12.75%, 13%, 13.25%, 13.5%, 13.75%, 14%, 14.25%, 14.5%, 14.75%, or 15% based on the weight of the printable etchant composition.

D. Thixotrope

The printable etchant compositions, such as etchant pastes, provided herein optionally include a thixotrope. Any thixotrope known in the art that is non-reactive with the acid-etching component of the composition can be included in the printable etchant compositions. Exemplary thixotropes that can be included in the printable etchant compositions include silica, including fumed silica and amorphous silica, clays, nanoclays, attapulgites, montmorillonite and other organo-clays, talcs, mica powder, fibrated minerals, calcium sulphonate derivatives, silicon oxide powder, amide waxes and polymer particles, such as polyamide resins, polyester amides, alkyds and oil-modified alkyds, and combinations thereof. Silica is a preferred thixotrope in the etchant paste compositions provided herein. Thixotropes can be used alone or in combination.

A thixotrope or combination of thixotropes generally is present in the range of 0-20% based on the weight of the printable etchant composition, and preferably are in the range of 5-15% based on the weight. of the printable etchant composition. A thixotrope or combination of thixotropes can be present in an amount that is 0.1%, 0.2%, 0.3%, 0.4%, 0.5%, 0.6%, 0.7%, 0.8%, 0.9%, 1%, 1.25%, 1.5%, 1.75%, 2%, 2.25%, 2.5%, 2.75%, 3%, 3.25%, 3.5%, 3.75%, 4%, 4.25%, 4.5%, 4.75%, 5%, 5.25%, 5.5%, 5.75%, 6%, 6.25%, 6.5%, 6.75%, 7%, 7.25%, 7.5%, 7.75%, 8%, 8.25%, 8.5%, 8.75%, 9%, 9.25%, 9.5%, 9.75%, 10%, 10.25%, 10.5%, 10.75%, 11%, 11.25%, 11.5%, 11.75%, 12%, 12.25%, 12.5%, 12.75%, 13%, 13.25%, 13.5%, 13.75%, 14%, 14.25%, 14.5%, 14.75%, 15%, 15.25%, 15.5%, 15.75%, 16%, 16.25%, 16.5%, 16.75%, 17%, 17.25%, 17.5%, 17.75%, 18%, 18.25%, 18.5%, 18.75%, 19%, 19.25%, 19.5%, 19.75% or 20% based on the weight of the printable etchant composition.

E. Print Additives

As with many printing inks, print additives, alone or in combination can be included in the printable etchant composition provided herein. Exemplary print additive include rheology/viscosity modifiers, wetting agents, surfactants, biocides, flow additives, anti-foaming agents, leveling agents, stabilizers, silicones, and plasticizers.

Rheology/viscosity modifiers can be included in the printable etchant compositions to increase the viscosity or to change the flow properties of the printable etchant compositions. Exemplary rheology/viscosity modifiers that can be include in the printable etchant compositions provided herein include styrene allyl alcohol, ethyl cellulose, methyl cellulose, 1-methyl-2-pyrrolidone (BYK®410), urea modified polyurethane (BYK®425), modified urea and 1-methyl-2-pyrrolidone (BYK®420), acrylic polymers, carboxyl methyl cellulose, xanthan gum, diutan gum and rhamsan gum.

Wetting agents and/or surfactants can be included in the printable etchant compositions for surface tension modification. Some preferred of such materials include polyether modified polydimethylsiloxane (BYK®307), xylene, ethylbenzene, blends of xylene and ethylbenzene (BYK®310), octamethylcyclotetrasiloxane (BYK®331), alcohol alkoxylates (e.g., BYK® DYNWET) and ethoxylates.

Bacteria, yeast and fungus can attack the components of the etchant compositions during storage, depending on the final pH of the etchant composition. The addition of biocide can increase the shelf life of the printable etchant compositions. The biocide can be selected from among algicide, bactericide, fungicide and a combination thereof. Examples of suitable biocides include salts and oxides of silver and zinc, sodium azide, 2-methyl-4-isothiazolin-3-one, 5-chloro-2-methyl-4-isothiazolin-3-one, thimerosal, iodopropynyl butylcarbamate, methyl paraben, ethyl paraben, propyl paraben, butyl paraben, isobutylparaben, benzoic acid, benzoate salts, sorbate salts, phenoxyethanol, triclosan, dioxanes, such as 6-acetoxy-2,2-dimethyl-1,3-dioxane (available as Giv Gard® DXN from Givaudam Corp., Vernier, Switzerland), benzyl alcohol, 7-ethyl-bicyclo-oxazolidine, benzalkonium chloride, boric acid, chloroacetamide, chlorhexidine and combinations thereof.

In order to decrease or eliminate foam formation, an anti-foaming agent can be included in the composition. Some preferred anti-foaming agents include silicones, such as polysiloxane (BYK®067 A), heavy petroleum naphtha alkylate (BYK®088), and blend of polysiloxanes, 2-butoxyethanol, 2-ethyl-1-hexanol and Stoddard solvent (BYK®020); and silicone-free anti-foaming agents, such as hydrodesulfurized heavy petroleum naphtha, butyl glycolate and 2-butoxyethanol and combinations thereof (BYK®052, BYK®A510, BYK®1790, BYK®354 and BYK®1752).

The printable etchant compositions provided herein also can include leveling agents. Exemplary leveling agents include polyacrylate in solvent naphtha (BYK®354), acrylic copolymer (BYK®381), octamethylcyclotetrasiloxane (BYK®307), polyether modified polydimethylsiloxane (BYK®333 and BYK®345), and polyacrylate (BYK®361N).

Stabilizers also can be included in the printable etchant compositions. Exemplary stabilizers include an ultraviolet light stabilizer and an ultraviolet light absorber.

The printable etchant compositions provided herein also can include a plasticizer. Exemplary plasticizers include a polyhydric alcohol ester type plasticizer, a phosphoric ester type plasticizer, phthalic ester, citric ester, fatty acid ester, a glycol type plasticizer and polybasic carboxylic ester, phthalic acid plasticizers, phosphate plasticizers, polycaprolactones, polyester plasticizers, propylene carbonate, dimethyl carbonate, ethylene carbonate, y-butylolactone, acetonitrile, sulfolane, dimethoxyethane, dimethylformamide, dimethylsulfoxide, and mixtures thereof.

When present, the total weight of the print additives generally is less than 20% based on the weight of the printable etchant composition, preferably less than 10% and more preferably less than 2% based on the weight of the printable etchant composition. The amount of print additives, when present, can be 0.05%, 0.06%, 0.07%, 0.08%, 0.09%, 0.1%, 0.15%, 0.2%, 0.25%, 0.3%, 0.35%, 0.4%, 0.45%, 0.5%, 0.55%, 0.6%, 0.65%, 0.7%, 0.75%, 0.8%, 0.85%, 0.9%, 0.95%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0% 5.1%, 5.2%, 5.3%, 5.4%, 5.5%, 5.6%, 5.7%, 5.8%, 5.9%, 6.0%, k 6.1%, 6.2%, 6.3%, 6.4%, 6.5%, 6.6%, 6.7%, 6.8%, 6.9%, 7.0%, 7.1%, 7.2%, 7.3%, 7.4%, 7.5%, 7.6%, 7.7%, 7.8%, 7.9%, 8.0%, 8.1%, 8.2%, 8.3%, 8.4%, 8.5%, 8.6%, 8.7%, 8.8%, 8.9%, 9.0%, 9.1%, 9.2%, 9.3%, 9.4%, 9.5%, 9.6%, 9.7%, 9.8%, 9.9% or 10.0% based on the weight of the printable etchant composition.

F. Colorants

For some applications, it may be advantageous to incorporate colorants in the form of pigments or dyes into the etchant paste. Suitable colorants include, but are not limited to, dyes, organic or inorganic pigments. The dyes include but are not limited to azo dyes, anthraquinone dyes, xanthene dyes, azine dyes, combinations thereof. Organic pigments can be one pigment or a combination of pigments, such as for instance Pigment Yellow Numbers 12, 13, 14, 17, 74, 83, 114, 126, 127, 174, 188; Pigment Red Numbers 2, 22, 23, 48:1, 48:2, 52, 52:1, 53, 57:1, 112, 122, 166, 170, 184, 202, 266, 269; Pigment Orange Numbers 5, 16, 34, 36; Pigment Blue Numbers 15, 15:3, 15:4; Pigment Violet Numbers 3, 23, 27; and/or Pigment Green Number 7. Inorganic pigments may be one of the following non-limiting pigments: iron oxides, titanium dioxides, chromium oxides, ferric ammonium ferrocyanides, ferric oxide blacks, Pigment Black Number 7 and/or Pigment White Numbers 6 and 7. Other organic and inorganic pigments and dyes can also be employed, as well as combinations that achieve the colors desired.

In addition to or in place of visible colorants, the printable etchant composition can contain UV fluorophores that are excited in the UV range and emit light at a higher wavelength (typically 400 nm and above). Examples of UV fluorophores include but are not limited to materials from the coumarin, benzoxazole, rhodamine, napthalimide, perylene, benzanthrones, benzoxanthones or benzothiaxanthones families. The addition of a UV fluorophore (such as an optical brightener for instance) could help maintain maximum visible light transmission while providing a way to inspect the printed etchant for pinholes or other defects. The amount of colorant, when present, generally is between 0.05% to 5% or between 0.1% and 1% based on the weight of the etchant composition.

An exemplary screen printable etchant paste for etching silver nano-wire based conductive films contains an acid-etching component containing an oxidizing agent in the range of 1-20 wt % and an acid in the range of 0.25%-15 wt %, at least one solvent in the range of 50-95 wt %, at least one resin in the range of 0-15 wt %, a thixotrope in the range of 2-20 wt %, and optionally anti-foaming agents, de-aerators, flow additives, rheology modifiers, wetting agents totaling in the range of 0-10 wt %. The acid-etching component contains an oxidizing agent. The acid-etching component can include cupric chloride in an amount of 2-15% based on the weight of the etchant paste. One solvent of the etchant paste can be ethylene glycol, which can be present in an amount that is less than 90% by weight of the etchant paste. One solvent of the etchant paste can be a liquid poly(ethylene)glycol and can be present in an amount that is less than 90% by weight of the etchant paste. One resin of the etchant paste can be polyvinylpyrrolidone and can be present in an amount that is 0.5-10% based on the weight of the etchant paste. The thixotrope can be silica powder and can be present in an amount that is 5-15% based on the weight of the etchant paste. When present, the acid can be hydrochloric acid and can be present in an amount that is 0.5-10% based on the weight of the etchant paste. The etchant paste

G. Viscosity

By modifying the viscosity and/or rheological properties of the composition, the printable etchant composition can be applied to a substrate via any suitable printing method, such as for example, screen printing, template, pad, stamp, ink jet and manual printing processes and the dispensing technique as well as by various forms of non-contact printing, including but not limited to aerosol jet printing and continuous and drop-on-demand ink jet printing. Viscosity generally is measured by an AR2000 cone and plate rheometer (TA Instruments, New Castle, Del.).

In a preferred method, the etchant paste is applied by screen printing. In another preferred method, the etchant paste is applied by aerosol jet printing. In another preferred method, the etchant paste is applied by continuous or drop-on-demand ink jet printing.

The viscosity ranges for the various forms of non-contact printing, including but not limited to continuous and drop-on-demand ink jet and for suitable forms of contact printing, including, but not limited to, flat bed screen, rotary screen, reverse gravure and flexography, are well known to those skilled in the art of printing. For example, see The Printing Ink Manual (5^{th} ed., Leach et al. eds. (2009), pages 549-551 and 554-555 for flexographic printing; pages 485-489 for gravure printing; pages 682, 683, 696 and 697 for inkjet printing; pages 348 and 381 for lithographic printing; and pages 600 and 603 for screen printing).

The viscosity of printable etchant compositions provided herein when formulated for aerosol jet printing generally have a viscosity range of 1 cP to 1,000 cP, preferably having a viscosity range of 30 cP to 500 cP as tested using parallel plate geometry in a TA AR2000ex rheometer at 25° C. at a shear rate of 10 sec⁻¹. In traditional inkjet inks, the ink viscosity generally needs to be less than 20 cP, preferably about 10-20 cP at 25° C. at a shear rate of 10 sec⁻¹ and the surface tension generally is less than about 60 dyne/cm.

The viscosity of printable etchant compositions provided herein when formulated for contact printing generally have a viscosity range of 5 cP and 4,000 cP at 25° C. at a shear rate of 10 sec⁻¹. For example, when formulated for flexographic printing, the printable etchant compositions can have a viscosity between at or about 20 cP to at or about 30 cP at 25° C. at a shear rate of 10 sec⁻¹. When formulated for screen printing (rotary or flatbed), the printable etchant compositions can have a viscosity between at or about 500 cP to at or about 4,000 cP at 25° C. at a shear rate of 10 sec⁻¹. When formulated for gravure printing, the printable etchant compositions can have a viscosity between at or about 10 cP to at or about 35 cP at 25° C. at a shear rate of 10 sec⁻¹.

Print quality of the etched areas on a substrate can be improved by modulating the viscosity of the printable etchant compositions. Generally, print quality was poor when the viscosity of the printable etchant composition was either too high or too low for the selected application method, and thus was unable to produce prints of acceptable quality. The viscosity of such formulations was adjusted using any of the typical methods of viscosity adjustment (change the ratio of raw materials (such as increasing the amount of a higher molecular weight solvent while concomitantly decreasing the amount of lower molecular weight solvent to increase the viscosity or decreasing the amount of higher molecular weight solvent while concomitantly increasing the amount of lower molecular weight solvent to decrease the viscosity), or including a viscosity modifier or thickener, or including a thixotrope to increase the viscosity, or decreasing the thixotrope to decrease the viscosity) to produce an etchant paste that has a more suitable viscosity for the selected application method while maintaining good end-use product performance characteristics of the etchant composition.

Alternately, the parameters of the selected printing process itself could be modified such that formulations exhibiting poor print quality would exhibit good printability. For example, in a screen printing process, it is possible to run at a wide range of viscosities, and a printable etchant composition demonstrating “poor printability” under one set of printing condition could be used to produce prints of good printability under different processing conditions (e.g., changes in screen mesh, squeegee, print speed, or combinations thereof).

### IV. PRINTING AN ETCHANT PASTE

Using the printable etchant compositions provided herein, any method known in the art of printing can be used for application of the printable etchant compositions provided herein. For example, the printable etchant compositions can be applied to a substrate using any known form of non-contact printing, such as aerosol jet printing and continuous and drop-on-demand ink jet printing. The printable etchant compositions can be applied to a substrate using any known form of contact printing, such as flat bed screen, rotary screen, reverse gravure and flexography. The printable etchant compositions provided herein can be used to create low visibility etchant patterns on a substrate. When etched, the etched areas of the film appear visually very similar to the non-etched areas of the film. For example, the etched and non-etched areas of the film have a very similar transparency, so that the conductive film looks uniform.

For example, provided are processes that involve printing a printable etchant composition, such as a printable etchant paste composition provided herein on selected areas of a substrate that require fewer materials and process steps than the more traditional methods based on etch resists and etchant baths. Typically, etching a pattern using an etchant paste provided herein involves the following steps:
1. Printing the etchant composition on a substrate;
2. Heated the printed etchant on the sample;
3. Stripping the etchant from the substrate; and
4. Drying the sample.

As discussed above, the printable etchant compositions provided herein can be formulated for application to a substrate using any printing method known in the art. Following application of the etchant paste to the substrate, the printed etchant then is heated. Any heating method known in the art can be used. For example, heating of the printed etchant composition on the substrate can be achieved using a conduction oven, an IR oven/furnace, by induction (heat induced by electromagnetic waves, such as microwaves) or using light (“photonic”) curing processes, such as a highly focused laser or a pulsed light system (e.g., available from Xenon Corporation (Wilmington, Mass. USA) or from NovaCentrix (Austin, Tex. USA)).

The conditions used to heat the printed etchant can be substrate dependent, particularly for thermally sensitive substrates. For example, a combination of shorter time at higher temperatures can be used, as well as a combination of longer time at lower temperatures. The selection of the combination of time and temperature is routine among those skilled in the art. Considerations in selecting the combination include, e.g., the boiling temperature of any acid component or the temperature at which an acid component may evolve fumes or any elevated temperature effects on components of the etchant, such as modifications in rheology that could effect resolution of the etching. Higher temperatures over extended periods of time also can result in undercutting of the etch resist.

The application of heat to the printed etchant can include exposing the substrate to anywhere from 80° C. to 250° C. for up to 10 min, and more preferably is exposed to anywhere from 80° C. to 160° C. for anywhere from about 10 seconds to 3 minutes. The transparent conductor can also be exposed to temperatures higher than 250° C. and can be as high as 400° C., depending on the type of substrate. For example, glass substrate can be heat-treated at a temperature range of about 350° C. to 400° C. Generally, heat treatments at higher temperatures (e.g., higher than 250° C.) may require the presence of a non-oxidative atmosphere, such as nitrogen or a noble gas.

The etchant printed substrate can be exposed to a temperature in the range of from at or about 20° C. to at or about 130° C. for a time period of up to 1 hour, generally for a time period between 10 seconds to 45 minutes. The printed etchant composition on the substrate can be heated at temperature or to reach a temperature of between at or about 60° C. and at or about 130° C. for a time period between 10 sec. and 240 sec., preferably between 70° C. and 110° C. for a time period between 20 sec. and 200 sec., most preferably between 75° C. and 85° C. for a time period between 60 sec. and 180 sec. In an exemplary embodiment, the printed etchant composition on the substrate can be heated at temperature or to reach a temperature of between 70° C. and 100° C. for a time period between 60 sec. and 120 sec., preferably at temperature or to reach a temperature of between 75° C. and 90° C. for a time period between 80 sec. and 100 sec.

After the printed etchant composition on the surface is heated, the printed etchant composition is removed (stripped) from the substrate. The etchant can be removed from the substrate using any method known in the art. An exemplary method is to subject the printed etchant composition on the substrate to a jet of a rinsing agent, e.g., deionized water, thereby spraying the etchant composition off of the substrate. The rinsing agent can contain deionized water, acetone, C₁-C₄ alcohol or combinations thereof. Additional rinsing and soaking steps, including exposure of the substrate to a caustic solution, also can be used in the stripping process.

After the printed etchant composition is stripped from the substrate, the substrate is dried. After drying, an etched area having a pattern is produced, where the etched area and the non-etched area of the substrate have a similar transparency. The etched areas of the substrate generally are about 250× less conductive than the non-etched areas of the film, preferably at least 200× less conductive than the non-etched areas of the film. When the substrate is a nanowire-based conductive film, the films patterned in this way have potential uses in visual display devices such as touch screens, liquid crystal displays, plasma display panels and in similar applications.

Substrates

The inventive printable etchant compositions, including printable etchant pastes described in this application, were developed for use on silver nanowire-based transparent conductive films (e.g., ClearOhm™ films from Cambrios Technologies Corp., Sunnyvale, Calif. USA). Such films include a plurality of interconnecting silver nano-wires to form a transparent conductive film. After etching with the inventive printable etchant compositions, including printable etchant pastes described in this application, the conductive film has a pattern of conductive and non-conductive areas, where the etched areas have low visibility. The etched films are suitable as a transparent electrode in visual display devices such as touch screens, liquid crystal displays, plasma display panels and similar applications. The inventive printable etchant compositions, including printable etchant paste composition, exhibit good performance on these films and is currently being recommended by the film manufacturer for patterning the silver nanowire-based transparent conductive films.

The inventive printable etchant compositions also can be used to etch other types of materials, e.g., metals, metal-coated glass, glass (rigid and flexible), oxides, and semiconductors. For example, the printable etchant compositions can be used to etch a substrate selected from among BT (Resin)—rigid printed circuit boards (PCBs), FR-4 (Flame Resistant 4)—rigid PCBs, polyimide film—flex circuits, a molybdenum (Mo) coating—flat panel display (FPD), polyethylene terephthalate (PET)—flex circuits, silica (SiO₂)—FPD, silicon (Si)—semiconductors, silicon nitride (Si₃N₄), SiNx coated multicrystalline and single crystalline wafers, glass (rigid and flexible), polyethylene naphthalate (PEN), polyetherimides, polyamides, and polyamide-imides copolymers.

Resistivity

Resistivity can be measured using any method known in the art. For example, in measuring resistance with the four-point-probe or van der Pauw methods, 4 contacts (2 for current, 2 for voltage) can be used to determine the sheet resistance of a layer while minimizing effects of contact resistance. The resistivity of the resulting film printed with the printable etchant composition also can be measured using a semiconductor parameter analyzer (e.g., a Model 4200-SCS Semiconductor Characterization System from Keithley Instruments, Inc., Cleveland, Ohio USA) connected to a Suss microprobe station to conduct measurements in an I-V mode. The sheet resistance of the conductive track (length L, width W and thickness t) can be calculated using the equation

R=Rₛₕₑₑₜ×^{L}/_{W}

where R is the resistance value measured by the equipment (in Ω), and Rₛₕₑₑₜ is expressed in Ω/square.

The resistance of the etched area of the substrate can be measured with a 4-pt probe. Generally, the etched area of the substrate has a resistance that is between 50× and 400× higher than un-etched area of the substrate. For example, in some examples, the etched area of the substrate was measured and found to have a resistance above 19990 ohm/sq as compared to the resistance of un-etched areas, which had a resistance of 50-200 ohm/sq. Thus, the etched area of the substrate can have a resistance that is 50×, 60×, 70×, 80×, 90×, 100×, 125×, 150×, 175×,200×, 225×, 250×, 275×, 300×, 325×, 350×, 375×, or 400× higher than an un-etched area of the substrate.

### EXAMPLES

The following examples illustrate specific aspects of the present invention and are not intended to limit the scope thereof in any respect and should not be so construed.

### Example 1

Example 1 is a representative example of a printable etchant paste composition and the process in which it is used to pattern a Cambrios ClearOhm™ film.

The etchant paste was prepared in the following manner. A container charged with 47.8 g of ethylene glycol and 30.0 g of polyethylene glycol (molecular weight=400) was heated with stirring to 60° C. 0.9 g of PVP (polyvinylpyrrolidione) was added with stirring until dissolved to produce a resin solution. 7.1 g of cupric chloride was added to the resin solution. Stirring and heating continued until all of the cupric chloride was dissolved. After complete dissolution of the cupric chloride, 7.1 g of hydrochloric acid was added slowly to the solution with stirring. After the addition of the hydrochloric acid was complete, 7.1 g of hydrophobic fumed silica was added to the solution in portions. Stirring and heating continued until a homogeneous thick paste was obtained.

The resulting paste was allowed to cool to room temperature before application to a substrate. The paste was applied to a 100T polyester screen and printed onto Cambrios ClearOhm™ film with a squeegee. The film was immediately baked in an oven (80° C. for 90 sec.) after which time the baked film was removed and the paste was stripped by spraying with deionized water. Additional rinsing and soaking steps, including exposure of the substrate to a caustic solution, also can be employed in the stripping process.

The resistance of the etched area of the film is measured with a 4-pt probe to be above 19990 ohm/sq as compared to the resistance of un-etched areas, which is 50-200 ohm/sq.

### Example 2

Example 2 is a representative example of a printable etchant paste composition. The role of resin in the printable etchant composition was investigated. Example 2 was prepared in a manner similar to that described in Example 1, with the formulation being modified as shown in Table 1.

TABLE 1
Examples of printable etchant paste formulations
and performance properties.

| | % | % | % | % | % | % | Perfor- |
|---|---|---|---|---|---|---|---|
| Example | CuCl₂ | Conc. HCl | EG | PEG | Silica | PVP | mance* |
| 1 | 7.1 | 7.1 | 47.8 | 30.0 | 7.1 | 0.9 | 1 |
| 2 | 6.6 | 6.6 | 54.3 | 22.9 | 9.5 | 0 | 4 |

*Performance: 1 = good (no performance issues); 2 = low etching power; 3 = poor print quality; 4 = poor strippability
Raw materials:
CuCl₂ = cupric chloride [copper(II) chloride, Aldrich];
Conc. HCl = concentrated HCL [37% hydrogen chloride, 63% water, Aldrich];
EG = ethylene glycol [Univar];
PEG = polyethylene glycol 400 [Dow];
silica = hydrophobic fumed silica [Aerosil ® R816, Evonik];
PVP = polyvinylpyrrolidone [Luvitec ® K90 powder]

The printable etchant paste of Example 2 was applied to a 100T polyester screen and printed onto Cambrios ClearOhm™ film with a squeegee. The film was immediately baked in an oven (80° C. for 90 sec.) after which time the baked film was removed and the paste was stripped by spraying with deionized water. The performance of the printable etchant paste was evaluated for etching power, print quality and strippability. When the overall performance of the printable etchant paste demonstrated no performance issues, it was designated as having a performance of 1. When the printable etchant paste demonstrated low etching power, it was designated as having a performance of 2. When the printable etchant paste demonstrated poor print quality, it was designated as having a performance of 3. When the printable etchant paste demonstrated poor strippability, it was designated as having a performance of 4. The results for Examples 1 and 2 are shown in Table 1. As can be seen from the data in Table 1, absence of a resin, such as polyvinylpyrrolidone, in the printable etchant paste results in poor strippability. One of the functions of the resin is to improve strippability. Improved strippability can result, e.g., by formation of a film upon heating thereby rendering the paste more easily removable from the substrate during the stripping process.

### Examples 3 to 11

Examples 3 to 11 are representative examples of printable etchant paste compositions. The effect of varying the amount of polyethylene glycol (PEG) in the printable etchant composition was investigated. Examples 3 to 11 were prepared and printed in a manner similar to that described in Examples 1 and 2. The formulation for each of Examples 3 to 11 is provided in Table 2. The performance characteristics also are the same as described in Example 2.

TABLE 2
Examples of printable etchant paste formulations
with varying amounts of PEG.

| Exam- | % | % | % | % | % | % | |
|---|---|---|---|---|---|---|---|
| ple | CuCl₂ | Conc. HCl | EG | PEG | Silica | PVP | Performance |
| 3 | 9.0 | 1.0 | 49.9 | 32 | 7 | 1.1 | 1 |
| 4 | 9.0 | 1.0 | 81.9 | 0 | 7 | 1.1 | 3 |
| 5 | 6.9 | 6.9 | 78.2 | 0 | 6.9 | 1.1 | 3 |
| 6 | 6.9 | 6.9 | 63.2 | 15 | 6.9 | 1.1 | 3 |
| 7 | 6.9 | 6.9 | 48.2 | 30 | 6.9 | 1.1 | 1 |
| 8 | 5.0 | 5.0 | 76.3 | 0 | 12 | 1.7 | 3 |
| 9 | 5.2 | 5.2 | 50.9 | 30.7 | 6.9 | 1.1 | 1 |
| 10 | 4.0 | 4.0 | 82.0 | 0 | 8 | 2 | 3 |
| 11 | 3.5 | 3.5 | 54.3 | 30.7 | 6.9 | 1.1 | 2 |

As demonstrated by the data, etchant pastes that include a high molecular weight solvent, such as PEG, tend to exhibit good print quality, and increasing the amount of PEG improved the observed print quality of the etchant pastes.

It should be noted that the examples that exhibited poor print quality (noted with a rating of 3 in the “Performance” column) exhibited a viscosity that was either too high or too low to produce prints of acceptable quality in the screen printing trials. It would be possible to adjust the viscosity of these formulations using any of the typical methods of viscosity adjustment (change the ratio of raw materials (such as increasing the amount of PEG while concomitantly decreasing the amount of ethylene glycol to increase the viscosity or decreasing the amount of PEG while concomitantly increasing the amount of ethylene glycol to decrease the viscosity), or including a viscosity modifier or thickener, or including a thixotrope to increase the viscosity, or decreasing the silica thixotrope to decrease the viscosity) to produce an etchant paste that has a more suitable viscosity while maintaining good end-use product performance characteristics.

Alternately, the printing process itself (screen mesh, squeegee, print speed, etc.) could be modified such that these examples would exhibit good printability. In the screen printing process, it is possible to run at a wide range of viscosities, and the examples described as having “poor printability” could be used to produce prints of good printability under different processing conditions and represent possible embodiments of the etchant pastes of the present invention.

As previously mentioned, in another embodiment the viscosity of the etchant pastes could be modified to make them suitable for other print methods.

### Examples 12 to 22

Examples 12 to 22 are representative examples of printable etchant paste compositions. The effect of including and varying the amount of acid (HCl) in the printable etchant composition was investigated. Examples 12 to 22 were prepared and printed in a manner similar to that described in Examples 1 and 2. The formulation for each of Examples 12 to 22 is provided in Table 3. The performance characteristics also are the same as described in Example 2.

TABLE 3
Examples of printable etchant paste formulations
with varying amounts of HCl.

| Exam- | % | % | % | % | % | % | |
|---|---|---|---|---|---|---|---|
| ple | CuCl₂ | Conc. HCl | EG | PEG | Silica | PVP | Performance |
| 12 | 6.9 | 6.9 | 33.7 | 44.5 | 6.9 | 1.1 | 1 |
| 13 | 6.9 | 5.2 | 49.2 | 30.7 | 6.9 | 1.1 | 1 |
| 14 | 6.9 | 3.5 | 50.9 | 30.7 | 6.9 | 1.1 | 1 |
| 15 | 6.9 | 1.7 | 52.7 | 30.7 | 6.9 | 1.1 | 1 |
| 16 | 6.9 | 0.9 | 53.5 | 30.7 | 6.9 | 1.1 | 1 |
| 17 | 6.9 | 0.4 | 54.0 | 30.7 | 6.9 | 1.1 | 3 |
| 18 | 6.9 | 0.4 | 54.0 | 29.9 | 7.6 | 1.2 | 3 |
| 19 | 6.9 | 0.0 | 54.4 | 30.7 | 6.9 | 1.1 | 3 |
| 20 | 6.9 | 0.0 | 55.3 | 27.4 | 9.0 | 1.4 | 3 |
| 21 | 5.2 | 3.5 | 52.6 | 30.7 | 6.9 | 1.1 | 1 |
| 22 | 5.2 | 1.7 | 54.4 | 30.7 | 6.9 | 1.1 | 3 |

As demonstrated by the data, etchant pastes that include cupric chloride and an acid, such as HCl, demonstrate good overall performance, including good print quality. Increasing the amount of HCl in the etchant paste, for example, from 0.9% to 6.9% based on the weight of the etchant composition, had minimal effect on the observed print quality of the etchant pastes that contained 6.9% cupric chloride. For etchant pastes containing lower amounts of cupric chloride, such as 5.2% based on the weight of the etchant composition, increasing the amount of HCl from 1.7% to 3.5% based on the weight of the composition improved the overall performance of the etchant.

### Examples 23 to 29

Examples 23 to 29 are representative examples of printable etchant paste compositions. The effect of varying the amount of cupric chloride in the printable etchant composition as well as its ratio to an acid in the paste were investigated. Examples 23 to 29 were prepared and printed in a manner similar to that described in Examples 1 and 2. The formulation for each of Examples 23 to 29 is provided in Table 4. The performance characteristics also are the same as described in Example 2.

TABLE 4
Examples of printable etchant paste formulations
and performance properties.

| Exam- | % | % | % | % | % | % | |
|---|---|---|---|---|---|---|---|
| ple | CuCl₂ | Conc. HCl | EG | PEG | Silica | PVP | Performance |
| 23 | 11.0 | 0.9 | 49.4 | 30.7 | 6.9 | 1.1 | 3 |
| 24 | 6.9 | 0.9 | 54.3 | 26.6 | 9.9 | 1.4 | 1 |
| 25 | 6.9 | 1.0 | 53.4 | 30.7 | 6.9 | 1.1 | 1 |
| 26 | 5.2 | 0.9 | 55.2 | 30.7 | 6.9 | 1.1 | 3 |
| 27 | 6.9 | 6.9 | 47.5 | 30.7 | 6.9 | 1.1 | 1 |
| 28 | 3.5 | 6.9 | 50.9 | 30.7 | 6.9 | 1.1 | 2 |
| 29 | 1.7 | 6.9 | 52.7 | 30.7 | 6.9 | 1.1 | 2 |

As demonstrated by the data, etchant pastes that include cupric chloride and an acid, such as HCl, demonstrate good overall performance, including good print quality. Increasing the amount of cupric chloride in the etchant paste independently from the HCl, for example, from 6.9% to 11% based on the weight of the etchant composition, had a negative effect on the observed print quality of the etchant pastes that contained 6.9% cupric chloride. Etchant compositions having a ratio of cupric chloride to HCl of 1:1 to about 7:1 demonstrated good overall performance. In formulations where the amount of PEG was held at 30.7% based on the weight of the composition, decreasing the ratio of cupric chloride to HCl from 1:1 to about 1:2 and from 1:1 to about 1:4 resulted in decreased etching power.

The present invention has been described in detail, including the preferred embodiments thereof, but is more broadly applicable as will be understood by those skilled in the art. It will be appreciated that those skilled in the art, upon consideration of the present disclosure, may make modifications and/or improvements on this invention that fall within the scope and spirit of the invention. Since modifications will be apparent to those of skill in this art, it is intended that this invention be limited only by the scope of the following claims.

1. A printable etchant composition for etching a substrate, comprising:
an oxidizing agent;
an acid;
a solvent; and
a resin,
wherein the printable etchant composition has a viscosity suitable for non-contact printing or contact printing.

2. The printable etchant composition of claim 1, wherein the oxidizing agent is selected from among cupric chloride, bromine, chlorine, iodine, iron nitrate, iron chloride, sodium hypochlorite, hydrogen peroxide, ammonium hydroxide, ammonium monopersulfate, potassium monopersulfate, sodium monopersulfate, ammonium persulfate, potassium persulfate, sodium persulfate, sodium or potassium peroxydisulfate, ferric nitrate, potassium iodate, acetic hydroperoxide, potassium permanganate and potassium iodide and combinations thereof.

3. The printable etchant composition of claim 1, wherein the acid is selected from among hydrochloric acid, bromic acid, chloric acid, nitric acid, nitrous acid, sulfuric acid, sulfurous acid, persulfuric acid, phosphoric acid, carboxylic acid group—containing compounds and sulfonic acid group-containing compounds and combinations thereof.

4. The printable etchant composition of any one of claim 1, wherein the acid is present in the range of 0.25% to 15% based on the weight of the etchant composition.

5. The printable etchant composition of any one of claim 1, wherein the acid is present in the range of 0.5% to 10% based on the weight of the etchant composition.

6. The printable etchant composition of any one of claim 1, wherein the oxidizing agent is present in an amount greater than at or about 1% based on the weight of the etchant composition.

7. The printable etchant composition of any one of claim 1, wherein the oxidizing agent is present in an amount greater than at or about 2% based on the weight of the etchant composition.

8. The printable etchant composition of any one of claim 1, wherein the oxidizing agent is present in an amount greater than at or about 6% based on the weight of the etchant composition.

9. The printable etchant composition of any one of claim 1, wherein the oxidizing agent is present in an amount less than 10% based on the weight of the etchant composition.

10. The printable etchant composition of any one of claim 1, wherein the ratio of oxidizing agent to acid in the etchant composition is between 1:1 and 9:1.

11. The printable etchant composition of any one of claim 1, wherein the solvent is selected from among water, glycerol, 1,2-propanediol, 1,4-butanediol, 1,3-butanediol, 1,5-pentanediol, and 2-ethyl-1-hexenol, ethylene glycol, diethylene glycol, dipropylene glycol, a polyethylene glycol and N-methyl-pyrrolidone and combinations thereof.

12. The printable etchant composition of any one of claim 1, wherein the solvent is selected from among diethylene glycol monobutyl ether; 2-(2-ethoxyethoxy)ethyl acetate; ethylene glycol; terpineol; trimethylpentanediol monoisobutyrate; 2,2,4-trimethyl-1,3-pentanediol monoisobutyrate (Texanol); dipropylene glycol monoethyl ether acetate; tripropylene glycol n-butyl ether; propylene glycol phenyl ether; dipropylene glycol n-butyl ether; dimethyl glutarate; dibasic ester mixture of dimethyl glutarate and dimethyl succinate; tetradecane, glycerol; phenoxy ethanol; dipropylene glycol; benzyl alcohol; acetophenone; 2,4-heptanediol; gamma-butyrolactone; phenyl carbitol; methyl carbitol; hexylene glycol; diethylene glycol monoethyl ether; 2-butoxyethanol; 1,2-dibutoxyethane; 3-butoxybutanol; and N-methylpyrrolidone and combinations thereof.

13. The printable etchant composition of any one of claim 1, wherein the solvent is selected from among C₁-C₆ alcohol; water; amyl acetate; butyl acetate; butyl ether; dimethylamine; toluene; and N-methyl-2-pyrrolidone and combinations thereof.

14. The printable etchant composition of any one of claim 1, wherein the solvent is polyethylene glycol or ethylene glycol or a combination thereof.

15. The printable etchant composition of any one of claim 1, wherein the solvent is present in an amount greater than 25% based on the weight of the etchant composition.

16. The printable etchant composition of any one of claim 1, wherein the solvent is present in the range of 50% to 95% based on the weight of the etchant composition.

17. The printable etchant composition of any one of claim 1, wherein the resin is selected from among polyethylene glycol, ethyl cellulose, methyl cellulose, carboxymethyl cellulose, hydroxypropyl cellulose, hydroxypropyl methyl cellulose, cellulose acetate, starch/starch derivatives, polypropylene glycol, cellulose acetate butyrate, xanthan gum, polyvinyl pyrrolidone and polymers based on acrylates or functionalized vinyl units, and combinations thereof.

18. The printable etchant composition of any one of claim 1, wherein the resin is selected from among homo- and copolymers of vinylpyrrolidone, polyvinyl alcohol, polyvinyl acetate, polyethylene glycols, copolymers of styrene and acrylate, copolymers of acrylic acid and methacrylic acid, copolymers of methacrylic acid and ethylacrylate, copolymers of methyl methacrylate and methacrylate, copolymers of acrylic acid and tertiary amino alkyl methacrylate, copolymers of methacrylate and tertiary amino alkyl methacrylate, copolymers of ethylacrylate methyl methacrylate and quaternary amino alkyl methacrylate, rhamsan gum, gellan gum, diutan gum, curdlan, gum arabic, chitosan and dextrans and combinations thereof.

19. The printable etchant composition of any one of claim 1, wherein the resin is present in an amount greater than at or about 0.5% based on the weight of the etchant composition.

20. The printable etchant composition of any one of claim 1, wherein the resin is present in an amount less than at or about 15% based on the weight of the etchant composition.

21. The printable etchant composition of any one of claim 1, wherein the resin is present in an amount less than at or about 2% based on the weight of the etchant composition.

22. The printable etchant composition of any one of claim 1, wherein the resin is polyvinylpyrrolidone.

23. The printable etchant composition of claim 1, further comprising a colorant.

24. The printable etchant composition of claim 1, further comprising a thixotrope.

25. The printable etchant composition of claim 1, wherein the thixotrope is selected from among silica, clay, nanoclay, attapulgite, montmorillonite and talc, mica powder, silicon oxide powder, amide waxes, polyamide resins, polyester amides, alkyds and oil-modified alkyds, and combinations thereof.

26. The printable etchant composition of claim 1, further comprising a rheology modifier selected from among styrene allyl alcohol, ethyl cellulose, methyl cellulose, 1-methyl-2-pyrrolidone, urea modified polyurethane, modified urea, 1-methyl-2-pyrrolidone, acrylic polymers, carboxyl methyl cellulose, xanthan gum, diutan gum and rhamsan gum and combinations thereof.

27. The printable etchant composition of claim 1, further comprising a wetting agent selected from among polyether modified polydimethyl siloxane, xylene, ethylbenzene, blends of xylene and ethylbenzene, octamethyl cyclotetrasiloxane, alcohol alkoxylates and ethoxylates.

28. The printable etchant composition of claim 1, further comprising a biocide selected from among salts and oxides of silver and zinc, sodium azide, 2-methyl-4-isothiazolin-3-one, 5-chloro-2-methyl-4-isothiazolin-3-one, thimerosal, iodopropynyl butylcarbamate, methyl paraben, ethyl paraben, propyl paraben, butyl paraben, isobutylparaben, benzoic acid, benzoate salts, sorbate salts, phenoxyethanol, triclosan, dioxanes, such as 6-acetoxy-2,2-dimethyl-1,3-dioxane, benzyl alcohol, 7-ethyl-bicyclo-oxazolidine, benzalkonium chloride, boric acid, chloroacetamide, chlorhexidine and combinations thereof.

29. The printable etchant composition of claim 1, further comprising an anti-foaming agent selected from among polysiloxane, heavy petroleum naphtha alkylate, 2-butoxyethanol, 2-ethyl-1-hexanol, hydro-desulfurized heavy petroleum naphtha, and butyl glycolate and combinations.

30. The printable etchant composition of claim 1, further comprising a leveling agent selected from among polyacrylate, acrylic copolymer, octamethylcyclotetrasiloxane, polyether modified polydimethylsiloxane and combinations thereof.

31. The printable etchant composition of claim 1, further comprising a plasticizer selected from among a polyhydric alcohol ester, a phosphoric ester, a phthalic ester, a citric ester, a fatty acid ester, a polycaprolactone, propylene carbonate, dimethyl carbonate, ethylene carbonate, y-butylolactone, acetonitrile, sulfolane, dimethoxyethane, dimethylformamide, and dimethylsulfoxide, and combinations thereof.

32. The printable etchant composition of claim 1, wherein the viscosity of the etchant composition is less than 20 cP at 10 sec⁻¹ at 25° C.

33. The printable etchant composition of claim 1, wherein the viscosity of the etchant composition is between 30 cP and 1000 cP at 10 sec⁻¹ at 25° C.

34. The printable etchant composition of claim 1, wherein the viscosity of the etchant composition is between 5 cP and 4,000 cP at 10 sec⁻¹ at 25° C.

35. The printable etchant composition of claim 1, wherein the viscosity of the etchant composition is greater than 500 cP at 10 sec⁻¹ at 25° C.

36. The printable etchant composition of claim 1, wherein the oxidizing agent is cupric chloride and the acid is hydrochloric acid.

37. The printable etchant composition of claim 1, wherein the non-contact printing is selected from among aerosol jet printing and continuous and drop-on-demand inkjet printing and wherein the contact printing is selected from among flat bed screen printing, rotary screen printing, reverse gravure printing and flexography.

38. (canceled)

39. The printable etchant composition of claim 1, wherein the substrate is a transparent conductive film, a metal, a metal-coated glass, a rigid glass, a flexible glass, an oxide or a semiconductor or a combination thereof.

40. The printable etchant composition of claim 1, wherein the substrate is a transparent conductive film formed by a plurality of interconnecting silver nanowires.

41-85. (canceled)
